(19) United States
(12) Patent Application Publication
(10) Pub. No.: US 2025/0383545 A1
(43) Pub. Date: Dec. 18, 2025

(54) ACTUATOR FOR HEAD-UP DISPLAY

(71) Applicant: HYUNDAI MOBIS CO., LTD., Seoul (KR)

(72) Inventor: Byung Ki KIM, Yongin-si (KR)

(73) Assignee: HYUNDAI MOBIS CO., LTD., Seoul (KR)

(21) Appl. No.: 19/190,893

(22) Filed: Apr. 28, 2025

(30) Foreign Application Priority Data
Jun. 17, 2024 (KR) 10-2024-0078118

(51) Int. Cl. G02B 27/01; B60K 35/23; F16F 15/02; F16H 25/20

(52) U.S. Cl. CPC G02B 27/0149; B60K 35/23; F16F 15/022; F16H 25/20; B60K 2360/31; B60K 2360/691; F16F 2222/08; F16F 2230/0005; F16H 2025/2031; F16H 2025/2075; G02B 2027/0154

(57) ABSTRACT

An actuator for a head-up display, includes a link attached to one end of an aspheric mirror, a driving force transmission including a lead screw to move the link, a driver to allow the lead screw to rotate along the axis of rotation of a motor as the motor is driven, a motor bracket disposed on top of the motor and attached to the driver to support the driver, a top motor mount disposed on the top of the motor, a bottom motor mount disposed on the bottom of the motor, a vibration damping part disposed between the top motor mount and the motor bracket, to absorb vibration from the motor, and a cantilever type dynamic vibration absorber disposed on both ends of the bottom motor mount, to absorb vibration from the motor.

### CROSS-REFERENCE TO RELATED APPLICATION

This application claims the benefit under 35 USC § 119 of priority to Korean Patent Application No. 10-2024-0078118 filed in the Korean Intellectual Property Office on Jun. 17, 2024 the entire contents of which are incorporated herein by reference for all purposes.

### BACKGROUND

### 1. Field

The present disclosure relates to an actuator for a head-up display driving module, and more particularly, to a vibration absorbing apparatus of an actuator for a head-up display.

### 2. Description of the Related Art

The content described below merely provides background information related to the present disclosure and does not constitute the related art.

A head-up display is a device that displays an image showing vehicle speed, remaining fuel, navigation information, etc. on a windshield that forms a front window of a vehicle. The head-up display is generally configured to present display information projected from a picture generation unit onto a windshield.

The head-up display rotates an aspheric mirror using a motor. As the revolutions per minute (RPM) of the motor increases, the vibration of the motor, i.e., the acceleration of the motor, increases. A conventional head-up display discloses the technology of suppressing the vibration of the motor by using a dynamic vibration absorber made of metal such as brass.

However, metal dynamic vibration absorbers such as brass ones are more massive than such members as the motor and a motor mount for fixing the motor. This can increase the manufacturing cost of an actuator for a head-up display and increase the total weight of the actuator for the head-up display. A problem with head-up displays according to the conventional art is that, if the motor is run at a high RPM, the vibration of the motor cannot be damped, and, as a result, noise is generated.

### SUMMARY

An embodiment of the present disclosure provides an actuator for a head-up display, that is capable of reducing the manufacturing cost by using a vibration damping part and a cantilever type dynamic vibration absorber and minimizing the total weight of the actuator for the head-up display.

An embodiment of the present disclosure provides an actuator for a head-up display, that is capable of dealing with low frequency vibrations by using a cantilever type dynamic vibration absorber and dampening vibrations and noise from the motor.

An embodiment of the present disclosure provides an actuator for a head-up display, that is capable of enhancing assemblability by adjusting the coupling angle of a lower mount and the coupling position of the cantilever type dynamic vibration absorber.

The problems to be solved by the present disclosure are not limited to the above-mentioned ones, and other problems not mentioned herein may be clearly understood by those skilled in the art from the description below.

According to an embodiment of the present disclosure, a vibration absorbing apparatus for a head-up display driving module is capable of reducing the manufacturing cost by using a vibration damping part and a cantilever type dynamic vibration absorber and minimizing the total weight of the actuator for the head-up display.

According to an embodiment of the present disclosure, a vibration absorbing apparatus for a head-up display driving module is capable of dealing with low frequency vibrations by using a cantilever type dynamic vibration absorber and dampening vibrations and noise from the motor.

According to an embodiment of the present disclosure, a vibration absorbing apparatus for a head-up display driving module is capable of enhancing assemblability by adjusting the coupling angle of a lower mount and the coupling position of the cantilever type dynamic vibration absorber.

In a general aspect of the disclosure, an actuator for a head-up display, includes: a link configured to be attached to one end of an aspheric mirror; a driving force transmission including a lead screw configured to move the link; a driver configured to allow the lead screw to rotate along the axis of rotation of a motor as the motor is driven; a motor bracket disposed on top of the motor and attached to the driver to support the driver; a top motor mount disposed on the top of the motor; a bottom motor mount disposed on the bottom of the motor; a vibration damping part disposed between the top motor mount and the motor bracket, and configured to absorb vibration from the motor; and a cantilever type dynamic vibration absorber disposed on both ends of the bottom motor mount, and configured to absorb vibration from the motor.

The vibration damping part may include: a first through hole formed through one portion of either ends of the top motor mount; a first damper fitted and attached to the motor bracket to absorb vibration from the motor, the first damper including a first damper hole corresponding to the first through hole; a first shoulder screw that penetrates through the first through hole, the first damper hole, and the motor bracket; and a first nut coupled to the first shoulder screw.

The cantilever type dynamic vibration absorber may include: a second through hole formed through one portion of either ends of the bottom motor mount; a second damper fitted and attached to the bottom motor mount to absorb vibration from the motor, the second damper including a second damper hole corresponding to the second through hole; a dynamic vibration absorber male screw that penetrates at least part of the second through hole and the second damper hole; and a second nut coupled to the dynamic vibration absorber male screw.

The dynamic vibration absorber male screw may be adjusted to a preset mass and a preset length so that a natural frequency of the motor and a target frequency of the cantilever type dynamic vibration absorber are calculated to be equal.

The cantilever type dynamic vibration absorber may further include a flange bush that penetrates at least part of the second through hole and the second damper hole, wherein the dynamic vibration absorber male screw may include: a first screw that penetrates the flange bush and is fastened to the second nut; a first shank that is formed to be larger in width than the first screw along the outer diameter of the first screw, the first shank extending toward the bottom of the motor; and a first head formed to be larger in width than the first shank along the outer diameter of the first shank.

The dynamic vibration absorber male screw may include: a second screw fastened to the second nut; a second shank formed to be larger in width than the second screw along the outer diameter of the second screw, and that penetrates through the second through hole and the second damper hole; a first shoulder formed to be larger in width than the second shank along the outer diameter of the second shank; and a second head formed to be smaller in width than the first shoulder along the inner diameter of the first shoulder, and that extends toward the bottom of the motor.

The cantilever type dynamic vibration absorber may further include a second shoulder screw that penetrates through the second through hole, the second damper hole, and the second nut, wherein the second shoulder screw may include: a third screw fastened to the second nut; a second shoulder formed to be larger in width than the third screw along the outer diameter of the third screw, and that penetrates through the second through hole and the second damper hole; and a third head formed to be larger in width than the second shoulder along the outer diameter of the second shoulder.

The second shoulder screw may include a tap hole that penetrates the third head and at least part of the second shoulder, wherein the dynamic vibration absorber male screw may include: a fourth screw coupled to the tap hole and extends toward the bottom of the motor; and a fourth head formed to be larger in width than the fourth screw along the outer diameter of the fourth screw.

The cantilever type dynamic vibration absorber may be disposed at a position corresponding to the area where the vibration damping part is disposed.

The bottom motor mount may be rotated at a predetermined angle with respect to the top motor mount and disposed at the bottom of the motor, to prevent physical interference with the vibration damping part.

At least one of the vibration damping part may be further configured to absorb noise from the motor, the cantilever type dynamic vibration absorber may be further configured to absorb noise from the motor, or a combination thereof.

In another general aspect of the disclosure, an actuator for a head-up display for a vehicle, includes: a link configured to be attached to one end of an aspheric mirror; a driving force transmission including a lead screw configured to move the link; a motor; a controller configured to control the motor; a driver configured to guide the lead screw to rotate along the axis of rotation of the motor as the motor is driven; a motor bracket disposed on top of the motor and attached to the driver to support the driver; a top motor mount disposed on the top of the motor; a bottom motor mount disposed on the bottom of the motor; a vibration damping part disposed between the top motor mount and the motor bracket, and configured to dampen vibration from the motor; and a cantilever type dynamic vibration absorber disposed on both ends of the bottom motor mount, and configured to absorb vibration from the motor.

At least one of the vibration damping part may be further configured to absorb noise from the motor, the cantilever type dynamic vibration absorber may be further configured to absorb noise from the motor, or a combination thereof.

The vibration damping part may include: a first through hole formed through the top motor mount; a first damper fitted and attached to the motor bracket to absorb vibration from the motor, the first damper including a first damper hole corresponding to the first through hole; a first shoulder screw that penetrates through the first through hole, the first damper hole, and the motor bracket; and a first nut coupled to the first shoulder screw.

The cantilever type dynamic vibration absorber may include: a second through hole formed through one portion of either ends of the bottom motor mount; a second damper fitted and attached to the bottom motor mount to absorb vibration from the motor, the second damper including a second damper hole corresponding to the second through hole; a dynamic vibration absorber male screw that penetrates at least part of the second through hole and the second damper hole; and a second nut coupled to the dynamic vibration absorber male screw.

The dynamic vibration absorber male screw may be adjustable to a preset mass and a preset length to set a natural frequency of the motor to be equivalent to a target frequency of the cantilever type dynamic vibration absorber.

### BRIEF DESCRIPTION OF THE DRAWINGS

FIG. 1 is a view showing an actuator for a head-up display according to an embodiment of the present disclosure.

FIG. 2 is an exploded perspective view showing an actuator for a head-up display according to an embodiment of the present disclosure.

FIG. 3 is a cross-sectional view taken along the line A-A′ of FIG. 1, which shows a cantilever type dynamic vibration absorber according to a first embodiment of the present disclosure.

FIG. 4 is a cross-sectional view taken along the line A-A′ of FIG. 1, which shows a cantilever type dynamic vibration absorber according to a second embodiment of the present disclosure.

FIG. 5 is a cross-sectional view taken along the line A-A′ of FIG. 1, which shows a cantilever type dynamic vibration absorber according to a third embodiment of the present disclosure.

FIG. 6 is a perspective view showing another example of the coupling position of a bottom motor bracket according to an embodiment of the present disclosure.

FIG. 7 is a graph showing vibration reduction curves of dynamic vibration absorbers according to the conventional art and the present disclosure.

### DETAILED DESCRIPTION

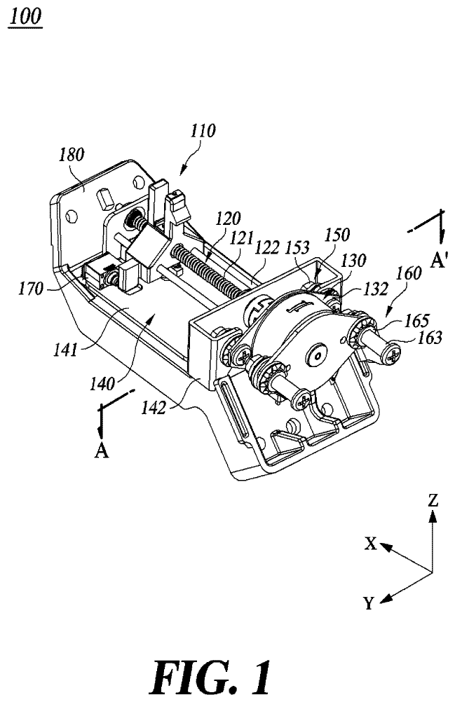

FIG. 1 is a view showing an actuator for a head-up display according to an embodiment of the present disclosure.

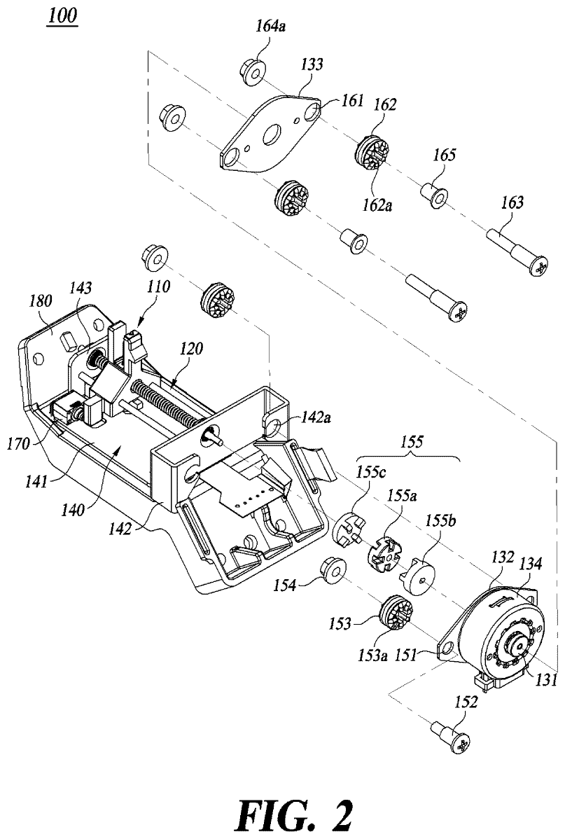

FIG. 2 is an exploded perspective view showing an actuator for a head-up display according to an embodiment of the present disclosure.

Referring to FIG. 1 and FIG. 2, an actuator 100 for a head-up display according to an embodiment of the present disclosure includes some or all of a link 110, a driving force transmission 120, a driver 130, a motor bracket 140, a top motor mount 132, a bottom motor mount 133, a vibration damping portion 150, and a cantilever type dynamic vibration absorber 160.

The link 110 may be attached to an aspheric mirror (not shown) and the driving force transmission 120. The link 110 may be configured to be attached to one end of the aspheric mirror. The link 110 may be disposed between the driving force transmission 120 and the aspheric mirror (not shown) to connect the components.

A spherical mount (not shown) may be formed on opposite ends of the aspheric mirror so as to allow the aspheric mirror (not shown) to rotate. The link 110 may interwork with the driving force transmission 120 and allow the aspheric mirror to rotate along the axis of rotation of a spherical mount (not shown).

The driving force transmission 120 may include some or all of a lead screw 121 and a guide shaft 122. The driving force transmission 120 may move in an arc on the other end of the link 110.

The lead screw 121 is configured to rotate by being connected and extending to the axis of rotation of the motor 131, and may be formed integrally with the driving force transmission 120 or formed as a detachable structure that can be assembled/dissembled. The lead screw 121 may cause the link 110 to move. A controller (e.g., a processor), not shown, may be configured to control or actuate the motor 131.

The guide shaft 122 may be formed between a lead screw mount 143 and a damper mount 142, spaced apart from and parallel to the lead screw 121. The guide shaft 122 may penetrate part of the link 110 and be attached to it. When the link 110 moves along the lead screw 121, the guide shaft 122 may guide the link 110 along the moving range so as to cause the link 110 to move without rotating.

The driver 130 may include some or all of a motor 131, the top motor mount 132, the bottom motor mount 133, and a body 134.

The motor 131 may be a DC motor, an AC motor, an induction motor, a synchronous motor, a step motor, a servo motor, a brushless motor, a linear motor, or a permanent magnet synchronous motor (PMSM).

The top motor mount 132 may be disposed to abut against a top surface of the motor 131. The top of the motor 131 refers to a portion that abuts against the axis of the motor 131. The top motor mount 132 may be formed in such a manner as to fully cover the top of the motor 131.

The top motor mount 132 may be attached to the damper mount 142 by using a first shoulder screw 152. Both ends of the top motor mount 132 may extend in a direction perpendicular to the axis of the motor 13 so as to be attached to the damper mount 142.

The bottom motor mount 133 may be disposed to abut against a bottom surface of the motor 131. The shape of the bottom motor mount 133 may correspond to the shape of the top motor mount 132. However, the shape of the bottom motor mount 133 is not limited to the shape of the top motor mount 132. The bottom motor mount 133 may be formed to fully cover the bottom of the motor 131.

Both ends of the bottom motor mount 133 may extend in a direction perpendicular to the axis of the motor 13 so as to be attached to the damper mount 142. The bottom motor mount 133 may be manufactured using a thin metal sheet.

The body 134 may be formed between the top motor mount 132 and the bottom motor mount 133. The body 134 may be configured to fully cover the side of the motor 131. The body 134 may be formed in such a manner as to be connected to the top motor mount 132. However, the shape of the body 134 is not limited to this.

The motor bracket 140 may include some or all of a housing mount 141, the damper mount 142, and the lead screw mount 143. The motor bracket 140 may be disposed on top of the motor 131. The motor bracket 140 may be attached to the driver 130 and support the driver 130.

The housing mount 141 may be disposed to abut against one surface of the housing 180. The housing 180 may fix the actuator for the head-up display in place in the head-up display. The housing 180 may include a plurality of bosses (not shown) and holes (not shown) for fixing the housing mount 141 in place.

The plurality of bosses (not shown) may determine the position where the housing mount 141 is attached to the housing 180. Housing holes (not shown) may be formed in one surface of the housing mount 141 so that tapping screws 181 penetrate therethrough. The tapping screws 181 may be fastened to the plurality of holes (not shown) formed in one surface of the housing 180 by penetrating through the housing holes (not shown).

A flexible cable 182 may be disposed between the housing 180 and the bracket of the motor 131. The flexible cable 182 refers to a conductive wire connected to the motor 131. The flexible cable 182 may be installed in such a manner as to be exposed to both sides, i.e., to the left and right.

A switch 170 may be disposed at one portion of the housing mount 141. The switch 170 may detect a point where the aspheric mirror reaches an operating limit.

The damper mount 142 may be disposed adjacent to the top motor mount 132. The damper mount 142 may be bent perpendicular to the housing mount 141. An open hole 142a may be formed in one surface of the damper mount 142 so that a first damper 153 is fitted and attached to it.

A lead screw 121 may penetrate one surface of the lead screw mount 143 and be attached to it. The lead screw mount 143 may be bent perpendicular to the housing mount 141.

The vibration damping part 150 may include some or all of a first through hole 151, the first shoulder screw 152, the first damper 153, a first nut 154, and a flexible coupling 155.

The first through hole 151 may be formed through one portion of either end of the top motor mount 132. The first shoulder screw 152 may penetrate through the first through hole 151.

The first damper 153 may be fitted and attached to the motor bracket 140 so as to absorb vibration from the motor 131. Specifically, it may be fitted and attached to the damper mount 142. The first damper 153 may damp the vibration of the motor 131 that passes through the top motor mount 132 and reduce noise produced from inside the actuator for the head-up display.

The first damper 153 may be disposed between the top motor mount 132 and the damper mount 142. The first damper 153 may include a first damper hole 153a that is formed through it, corresponding to the first through hole 151.

The first damper hole 153a may be formed through one side of the first damper 153 so that the first shoulder screw 152 penetrates through it. The first nut 154 may be coupled to the first shoulder screw 152 which has passed through the first through hole 151, the first damper hole 153a, and the open hole 142a.

The flexible coupling 155 may compensate for an eccentricity between the axis of rotation of the motor 131 and the axis of rotation of the lead screw 121. The flexible coupling 155 may have a first hub 155b and a second hub 155c which are coupled to opposite sides of a spacer 155a.

The axis of rotation of the motor 131 may be fitted and attached to the first hub 155b coupled to one side of the flexible coupling 155. The lead screw 121 may be fitted and attached to the second hub 155c coupled to the other side of the flexible coupling 155.

Even if the axis of rotation of the motor 131 and the axis of rotation of the lead screw 121 do not coincide with each other, the eccentricity between the axes can be compensated for by using the spacer 155a. The flexible coupling 155 according to an embodiment of the present disclosure may be an Oldham coupling, for example. Here, the Oldham coupling is used as a coupling for compensating for the eccentricity between the axes coupled to the two sides. However, the type of the flexible coupling 155 is not limited to this.

The cantilever type dynamic vibration absorber 160 may include a second through hole 161, a second damper 162, a dynamic vibration absorber male screw 163, and a second nut 164. The cantilever type dynamic vibration absorber 160 may be disposed on both ends of the bottom motor mount 133.

The second through hole 161 may be formed through one portion of either end of the bottom motor mount 133.

The second damper 162 may be fitted and attached to the bottom motor mount 133 so as to absorb vibration from the motor 131. The second damper 162 may damp the vibration of the motor 131 that passes through the bottom motor mount 133 and reduce noise generated from inside the actuator for the head-up display. The second damper 162 may include a second damper hole 162a that is formed through it, corresponding to the second through hole 161.

The dynamic vibration absorber screw 163 may penetrate at least a part of the second through-hole 161 and the second damper hole 162a. The dynamic vibration male screw 163 may be adjusted to a preset mass and a preset length so that the natural frequency of the motor 131 and a target frequency of the cantilever type dynamic vibration absorber 160 are calculated to be equal.

By adjusting the axial length of the dynamic vibration absorber male screw 163, the dynamic vibration absorber male screw 163 is cantilevered. The length of the dynamic vibration absorber male screw 163 may be determined based on the amplitude, frequency, etc. of vibrations produced from the motor 131. The length of the dynamic vibration absorber male screw 163 may be adjusted so that the natural frequency of the motor 131 and the natural frequency of the cantilever type dynamic vibration absorber 160 coincide with each other.

The second nut 164 may be coupled to the dynamic vibration absorber male screw 163 penetrating through the second through hole 161 and the second damper hole 162a.

The cantilever type dynamic vibration absorber 160 may be disposed in a position corresponding to the area where the vibration damping part 150 is disposed.

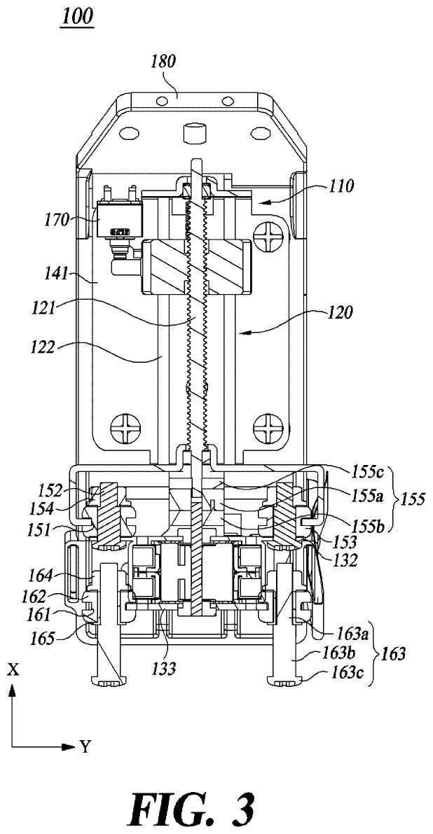

FIG. 3 is a cross-sectional view taken along the line A-A′ of FIG. 1, which shows a cantilever type dynamic vibration absorber according to a first embodiment of the present disclosure.

Referring to FIG. 3, the cantilever-type dynamic vibration absorber 160 according to the first embodiment of the present disclosure may further include a flange bush 165 that at least partially penetrates the second through-hole 161 and the second damper hole 162a. A flange portion of the bush 165 may be configured to cover at least part of the top of the second damper 162. The force exerted on the flange portion may be distributed to the second damper 162, thereby increasing the overall compression force.

The dynamic vibration absorber male screw 163 according to the first embodiment of the present disclosure may include a first screw 163a, a first shank 163b, and a first head 163c.

The first screw 163a may penetrate the flange bush 165. The first screw 163a may be fastened to the second nut 164.

The first shank 163b may be formed by being connected to the first screw 163a. The first shank 163b may be formed to be larger in width than the first screw 163a along the outer diameter of the first screw 163a. The first shank 163b may extend toward the bottom of the motor 131. The length of the first shank 163b may be adjusted so that the natural frequency of the motor 131 and the natural frequency of the cantilever type dynamic vibration absorber 160 coincide with each other.

The first head 163c may be formed by being connected to the first shank 163b. The first head 163c may be formed to be larger in width than the first shank 163b along the outer diameter of the first shank 163b.

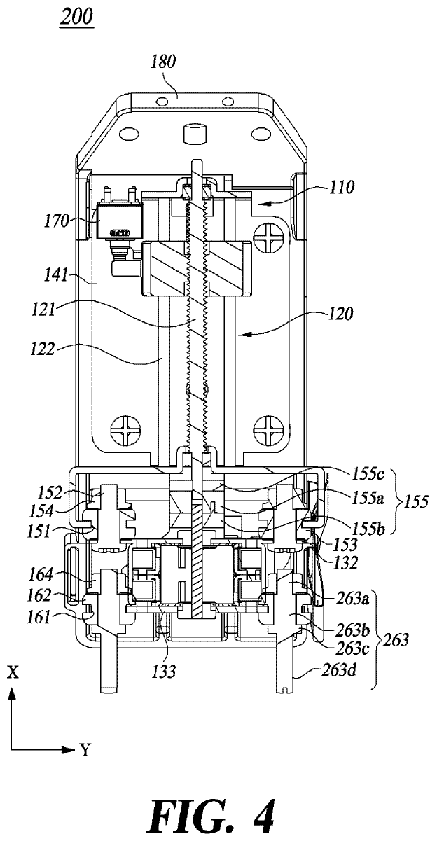

FIG. 4 is a cross-sectional view taken along the line A-A′ of FIG. 1, which shows a cantilever type dynamic vibration absorber according to a second embodiment of the present disclosure. Here, descriptions that overlap with the descriptions of the actuator for the head-up display according to the embodiment in FIGS. 1 and 2 will be omitted.

Referring to FIG. 4, the cantilever type dynamic vibration absorber 160 according to the second embodiment of the present disclosure may include some or all of a second screw 263a, a second shank 263b, a first shoulder 263c, and a second head 263d.

The second screw 263a may be fastened to the second nut 164. The second shank 263b may be formed by being connected to the second screw 263a. The second shank 263b may be formed to be larger in width than the second screw 263a along the outer diameter of the second screw 263a. The second shank 263b may penetrate at least part of the second through-hole 161 and the second damper hole 162a.

The first shoulder 263c may be formed by being connected to the second screw 263a. The first shoulder 263c may be formed to be larger in width than the second shank 263b along the outer diameter of the second shank 263b. The first shoulder 263c may perform the same role as the flange portion of the flange bush.

The second head 263d may be formed by being connected to the first shoulder 263c. The second head 263d may be formed to be smaller in width than the first shoulder 263c along the inner diameter of the first shoulder 263c. The second head 263d may extend toward the bottom of the motor 131. The length of the second head 263d may be adjusted so that the natural frequency of the motor 131 and the natural frequency of the cantilever type dynamic vibration absorber 160 coincide with each other.

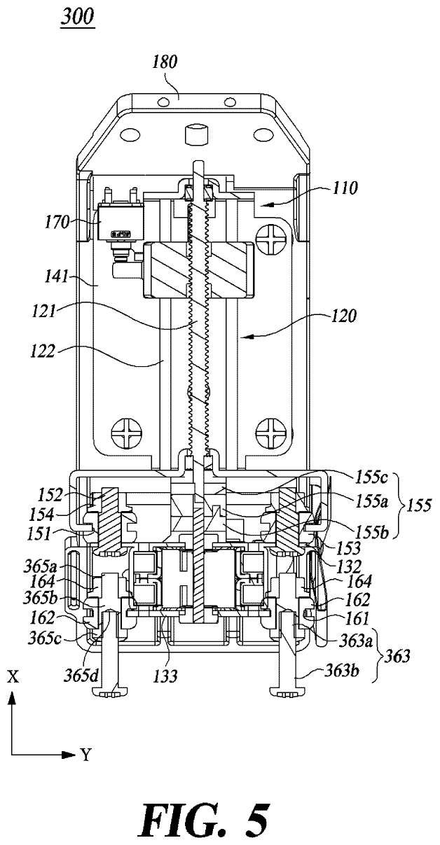

FIG. 5 is a cross-sectional view taken along the line A-A′ of FIG. 1, which shows a cantilever type dynamic vibration absorber according to a third embodiment of the present disclosure. Here, descriptions that overlap with the descriptions of the actuator for the head-up display according to the embodiment in FIGS. 1 and 2 will be omitted.

The cantilever type dynamic vibration absorber 160 according to the third embodiment of the present disclosure may include a second shoulder screw 365 that penetrates through the second through hole 161, the second damper hole 162a, and the second nut 164.

The second shoulder screw 365 may include some or all of a third screw 365a, a second shoulder 365b, and a third head 365c.

The third screw 365a may be fastened to the second nut 164. The second shoulder 365b may be formed by being connected to the third screw 365a. The second shoulder 365b may be formed to be larger in width than the third screw 365a along the outer diameter of the third screw 365a. The second shoulder 365b may penetrate at least part of the second through-hole 161 and the second damper hole 162a.

The third head 365c may be formed by being connected to the second shoulder 365b. The third head 365c may be formed to be larger in width than the second shoulder 365b along the outer diameter of the second shoulder 365b.

The second shoulder screw 365 may include a tap hole 365d that penetrates the third head 365c and at least part of the second shoulder 365b.

The dynamic vibration absorber male screw 163 according to the third embodiment of the present disclosure may include some or all of a fourth screw 163a and a fourth head 363b.

The fourth screw 363a may penetrate through at least part of the tap hole 365d and be coupled to the second shoulder screw 365. The fourth screw 363a may extend toward the bottom of the motor 131. The length of the fourth head 363b may be adjusted so that the natural frequency of the motor 131 and the natural frequency of the cantilever type dynamic vibration absorber 160 coincide with each other.

The fourth head 363b may be formed by being connected to the fourth screw 363a. The fourth head 363b may be formed to be larger in width than the fourth screw 363a along the outer diameter of the fourth screw 363a.

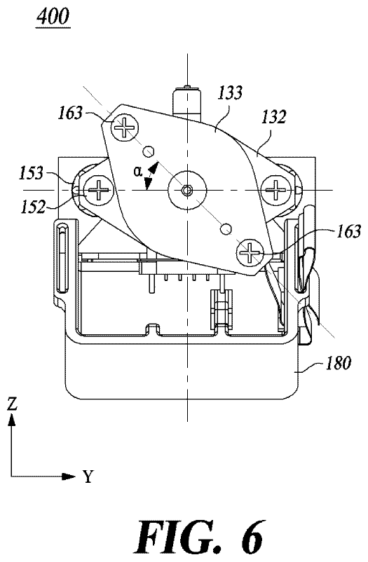

FIG. 6 is a perspective view showing another example of the coupling position of a bottom motor bracket according to an embodiment of the present disclosure. Here, descriptions that overlap with the descriptions of the actuator for the head-up display according to the embodiment in FIGS. 1 and 2 will be omitted.

Referring to FIG. 6, the bottom motor mount 133 may be rotated at a certain angle with respect to the top motor mount 132. Once rotated at a certain angle, the bottom motor mount 133 may be disposed at the bottom of the motor 131, thereby preventing physical interference with the vibration damping part 150.

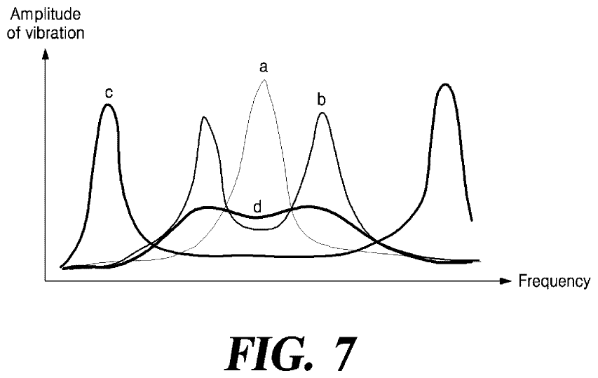

FIG. 7 is a graph showing vibration reduction curves of dynamic vibration absorbers according to the conventional art and the present disclosure.

The line a of FIG. 7 represents a vibration reduction curve for a head-up display in which the vibration damping part 150 and the cantilever type dynamic vibration absorber 160 are not installed. The line b of FIG. 7 represents a vibration reduction curve where only the cantilever type dynamic vibration absorber 160 is installed. In the line a, the amplitude of vibration varies widely with frequency, and the effect of vibration reduction disappears as the operation of the main structure goes into resonance. In the line b, the cantilever type dynamic vibration absorber 160 reduces some of the vibration but the vibration level is still high.

The line c of FIG. 7 represents a vibration reduction curve obtained by increasing the weight of the mass body of the cantilever type dynamic vibration absorber 160. The line d of FIG. 7 represents a vibration reduction curve obtained when a cantilever type dynamic vibration absorber 160 having a vibration damping part 160 and dampers is installed, as in the embodiments of the present disclosure. In the line c, a shift of the resonant frequency away from the operation range took place, and, as a result, the amplitude of vibration in the operation range can be reduced; however, there still remains issues concerning the safety of the cantilever type dynamic vibration absorber 160 and size limitations depending on the installation position.

The line d shows a significant decrease in vibration response at two resonant frequencies, which may result in an overall decrease in the amplitude of vibration. Moreover, the load on the operation range can be reduced, and the safety of the cantilever type dynamic vibration absorber can be improved.

What is claimed is:

1. An actuator for a head-up display, the actuator comprising:
a link configured to be attached to one end of an aspheric mirror;
a driving force transmission including a lead screw configured to move the link;
a driver configured to allow the lead screw to rotate along the axis of rotation of a motor as the motor is driven;
a motor bracket disposed on top of the motor and attached to the driver to support the driver;
a top motor mount disposed on the top of the motor;
a bottom motor mount disposed on the bottom of the motor;
a vibration damping part disposed between the top motor mount and the motor bracket, and configured to absorb vibration from the motor; and
a cantilever type dynamic vibration absorber disposed on both ends of the bottom motor mount, and configured to absorb vibration from the motor.

2. The actuator of claim 1, wherein the vibration damping part includes:
a first through hole formed through one portion of either ends of the top motor mount;
a first damper fitted and attached to the motor bracket to absorb vibration from the motor, the first damper including a first damper hole corresponding to the first through hole;
a first shoulder screw that penetrates through the first through hole, the first damper hole, and the motor bracket; and
a first nut coupled to the first shoulder screw.

3. The actuator of claim 1, wherein the cantilever type dynamic vibration absorber includes:
a second through hole formed through one portion of either ends of the bottom motor mount;
a second damper fitted and attached to the bottom motor mount to absorb vibration from the motor, the second damper including a second damper hole corresponding to the second through hole;
a dynamic vibration absorber male screw that penetrates at least part of the second through hole and the second damper hole; and
a second nut coupled to the dynamic vibration absorber male screw.

4. The actuator of claim 3, wherein the dynamic vibration absorber male screw is adjusted to a preset mass and a preset length so that a natural frequency of the motor and a target frequency of the cantilever type dynamic vibration absorber are calculated to be equal.

5. The actuator of claim 4, wherein the cantilever type dynamic vibration absorber further includes a flange bush that penetrates at least part of the second through hole and the second damper hole, and
wherein the dynamic vibration absorber male screw includes:
a first screw that penetrates the flange bush and is fastened to the second nut;
a first shank that is formed to be larger in width than the first screw along the outer diameter of the first screw, the first shank extending toward the bottom of the motor; and
a first head formed to be larger in width than the first shank along the outer diameter of the first shank.

6. The actuator of claim 4, wherein the dynamic vibration absorber male screw includes:
a second screw fastened to the second nut;
a second shank formed to be larger in width than the second screw along the outer diameter of the second screw, and that penetrates through the second through hole and the second damper hole;
a first shoulder formed to be larger in width than the second shank along the outer diameter of the second shank; and
a second head formed to be smaller in width than the first shoulder along the inner diameter of the first shoulder, and that extends toward the bottom of the motor.

7. The actuator of claim 4, wherein the cantilever type dynamic vibration absorber further includes a second shoulder screw that penetrates through the second through hole, the second damper hole, and the second nut,
wherein the second shoulder screw includes:
a third screw fastened to the second nut;
a second shoulder formed to be larger in width than the third screw along the outer diameter of the third screw, and that penetrates through the second through hole and the second damper hole; and
a third head formed to be larger in width than the second shoulder along the outer diameter of the second shoulder.

8. The actuator of claim 7, wherein the second shoulder screw includes a tap hole that penetrates the third head and at least part of the second shoulder, and
wherein the dynamic vibration absorber male screw includes:
a fourth screw coupled to the tap hole and extends toward the bottom of the motor; and
a fourth head formed to be larger in width than the fourth screw along the outer diameter of the fourth screw.

9. The actuator of claim 4, wherein the cantilever type dynamic vibration absorber is disposed at a position corresponding to the area where the vibration damping part is disposed.

10. The actuator of claim 4, wherein the bottom motor mount is rotated at a predetermined angle with respect to the top motor mount and disposed at the bottom of the motor, to prevent physical interference with the vibration damping part.

11. The actuator of claim 1, wherein at least one of:
the vibration damping part is further configured to absorb noise from the motor;
the cantilever type dynamic vibration absorber is further configured to absorb noise from the motor; or
a combination thereof.

12. An actuator for a head-up display of a vehicle, the actuator comprising:
a link configured to be attached to one end of an aspheric mirror;
a driving force transmission including a lead screw configured to move the link;
a motor;
a controller configured to control the motor;
a driver configured to guide the lead screw to rotate along the axis of rotation of the motor as the motor is driven;
a motor bracket disposed on top of the motor and attached to the driver to support the driver;
a top motor mount disposed on the top of the motor;
a bottom motor mount disposed on the bottom of the motor;
a vibration damping part disposed between the top motor mount and the motor bracket, and configured to dampen vibration from the motor; and
a cantilever type dynamic vibration absorber disposed on both ends of the bottom motor mount, and configured to absorb vibration from the motor.

13. The actuator of claim 12, wherein at least one of:
the vibration damping part is further configured to absorb noise from the motor;
the cantilever type dynamic vibration absorber is further configured to absorb noise from the motor; or
a combination thereof.

14. The actuator of claim 12, wherein the vibration damping part includes:
a first through hole formed through the top motor mount;
a first damper fitted and attached to the motor bracket to absorb vibration from the motor, the first damper including a first damper hole corresponding to the first through hole;
a first shoulder screw that penetrates through the first through hole, the first damper hole, and the motor bracket; and
a first nut coupled to the first shoulder screw.

15. The actuator of claim 12, wherein the cantilever type dynamic vibration absorber includes:
a second through hole formed through one portion of either ends of the bottom motor mount;
a second damper fitted and attached to the bottom motor mount to absorb vibration from the motor, the second damper including a second damper hole corresponding to the second through hole;
a dynamic vibration absorber male screw that penetrates at least part of the second through hole and the second damper hole; and
a second nut coupled to the dynamic vibration absorber male screw.

16. The actuator of claim 15, wherein the dynamic vibration absorber male screw is adjustable to a preset mass and a preset length to set a natural frequency of the motor to be equivalent to a target frequency of the cantilever type dynamic vibration absorber.
